(19) United States
(12) Patent Application Publication
(10) Pub. No.: US 2025/0292084 A1
(43) Pub. Date: Sep. 18, 2025

(54) METHOD, APPARATUS, SYSTEM, AND COMPUTER PROGRAM FOR ADAPTIVE ROUTING OF MIXTURE-OF-EXPERTS LANGUAGE MODEL

(71) Applicant: SAMSUNG SDS CO., LTD., Seoul (KR)

(72) Inventors: Youngjun KIM, Seoul (KR); Sungyoon KIM, Seoul (KR); Kihyo MOON, Seoul (KR)

(73) Assignee: SAMSUNG SDS CO., LTD., Seoul (KR)

(21) Appl. No.: 19/077,255

(22) Filed: Mar. 12, 2025

(30) Foreign Application Priority Data
Mar. 12, 2024 (KR) 10-2024-0034216
May 29, 2024 (KR) 10-2024-0070148

(51) Int. Cl. G06N 3/08; G06N 3/045

(52) U.S. Cl. CPC G06N 3/08; G06N 3/045

(57) ABSTRACT

A processor-implemented method including collecting update setting values for a mixture-of-experts language model, executing inference using the mixture-of-experts language model and collecting expert weights generated by a router of a layer of the mixture-of-experts language model to select an expert network to distribute tokens from among a plurality of expert networks, and updating a selected number of expert networks to be activated for the router of the layer, based on the expert weights and the update setting values.

### CROSS-REFERENCE TO RELATED APPLICATION(S)

This application claims the benefit under 35 USC § 119(a) of 35 U.S.C. 119 to Korean Patent Applications No. 10-2024-0034216, filed on Mar. 12, 2024 and No. 10-2024-0070148, filed on May 29, 2024, in the Korean Intellectual Property Office, the entire disclosure of which is incorporated herein by reference for all purposes.

### BACKGROUND OF THE INVENTION

### 1. Field of the Invention

The present disclosure relates to an adaptive routing method, apparatus, system, and computer program for a mixture-of-experts (MoE) language model and, more specifically, to an adaptive routing method, apparatus, system, and computer program for an MoE language model capable of processing the MoE language model by adaptively changing the number of expert networks activated in an MoE block.

### 2. Description of the Prior Art

Recently, a wide range of technologies and services have been provided in various fields on the basis of neural network models such as a large language model (LLM).

In this regard, language models based on the mixture-of-experts (MoE) architecture have recently been attracting attention for their improved performance.

More specifically, the MoE language model operates by replacing the feed forward network (FFN) in the conventional transformer layer with a router and a plurality of expert networks, and by activating only some of the plurality of expert networks during the inference process, thereby bring the advantage of improved performance such as faster inference, compared to language models with a similar number of parameters.

However, the conventional MoE language model is implemented by activating only a predetermined number of expert networks among the plurality of expert networks. For example, the Mixtral model, which is one of the representative MoE language models, operates by selectively activating only two of eight expert networks.

However, the MoE language model has a trade-off relationship in which, if the number of expert networks activated during the inference process decreases, the inference speed increases but the accuracy decreases, and in which, if the number of expert networks activated increases, the inference speed decreases but the accuracy increases. Therefore, if a fixed number of expert networks are activated, it is difficult to optimize processing depending on various operating environments, which increases the processing time or increases the computing resources required.

Furthermore, since the conventional MoE language model activates a fixed number of expert networks, it is impossible to adaptively respond to changes in the characteristics of the input data, making it difficult to perform efficient processing.

Accordingly, a method is required to enable processing while changing the number of expert networks activated in the MoE language model and to enable efficient processing by adaptively responding to the characteristics of input data, but an appropriate solution has not yet been presented.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided processor-implemented method including collecting update setting values for a mixture-of-experts language model, executing inference using the mixture-of-experts language model and collecting expert weights generated by a router of a layer of the mixture-of-experts language model to select an expert network to distribute tokens from among a plurality of expert networks, and updating a selected number of expert networks to be activated for the router of the layer, based on the expert weights and the update setting values.

The collecting of the setting values may include collecting a first ratio of a first router, the first router having a first selected number set to a first value and a second ratio of a second router, the second router having a second selected number set to a second value, from among all routers included in the mixture-of-experts language model and updating conditions for the selected number.

The updating may include updating the selected number configured in the router of the layer, responsive to the updated conditions being satisfied, based on the collected expert weights, the first ratio, and the second ratio.

The expert weights may be values calculated based on a degree of association between the tokens and the plurality of expert networks, the expert weights including a plurality of weight elements corresponding to the plurality of expert networks, each of the weight elements may be a value between 0 and 1, and a sum of the plurality of weight elements corresponding to the plurality of expert networks may be 1.

The expert weights may be calculated by the router of the layer, based on a ratio for distributing the tokens to the plurality of expert networks.

The updating may include calculating a first bias value indicating a first degree of bias of all expert weights for all layers of the mixture-of-experts language model and a first uniformity value indicating a degree of uniformity therefor, based on the expert weights and the first and second ratios, calculating a second bias value indicating a second degree of bias of specific expert weights for a specific layer of the mixture-of-experts language model and a second uniformity value indicating a degree of uniformity therefor, based on the expert weights and the first and second ratios, and determining the selected number of expert networks to be activated for a specific router of the specific layer by comparing the first bias value and the first uniformity value with the second bias value and the second uniformity value.

The determining may include determining the selected number of expert networks to be activated for the specific router by combining comparison results between the first bias value and the second bias value and comparison results between the first uniformity value and the second uniformity value.

The determining may include dynamically changing the selected number of expert networks to be activated for the specific router responsive to the first bias value being smaller than the second bias value and to the first uniformity value being larger than the second uniformity value by considering the expert weight for each token.

In a general aspect, here is provided an apparatus including a processor configured to execute instructions and a memory storing the instructions, and an execution of the instructions configures the processor to collect update setting values for a mixture-of-experts language model, execute inference using the mixture-of-experts language model and collecting expert weights generated by a router of a layer of the mixture-of-experts language model to select an expert network to distribute tokens from among a plurality of expert networks, and update a selected number of expert networks to be activated for the router of the layer, based on the expert weights and the update setting values.

The collecting of the setting values may include collecting a first ratio of a first router, the first router having a first selected number set to a first value and a second ratio of a second router, the second router having a second selected number set to a second value, from among all routers included in the mixture-of-experts language model and updating conditions for the selected number.

The updating may include updating the selected number configured in the router of the layer responsive to the updated conditions being satisfied, based on the collected expert weights, the first ratio, and the second ratio.

The expert weights may be values calculated based on a degree of association between the tokens and the plurality of expert networks, the expert weight including a plurality of weight elements corresponding to the plurality of expert networks, each of the weight elements may be a value between 0 and 1, and a sum of the plurality of weight elements corresponding to the plurality of expert networks may be 1.

The expert weights may be calculated by the router of the layer, based on a ratio for distributing the tokens to the plurality of expert networks.

The updating may include calculating a first bias value indicating a degree of bias of all expert weights for all layers of the mixture-of-experts language model and a first uniformity value indicating the degree of uniformity therefor based on the expert weights and the first and second ratios, calculating a second bias value indicating a second degree of bias of specific expert weights for a specific layer of the mixture-of-experts language model and a second uniformity value indicating a degree of uniformity therefor based on the expert weights and the first and second ratios, and determining the selected number of expert networks to be activated for a specific router of the specific layer by comparing the first bias value and the first uniformity value with the second bias value and the second uniformity value.

The determining may include determining the selected number of expert networks to be activated for the specific router by combining comparison results between the first bias value and the second bias value and comparison results between the first uniformity value and the second uniformity value.

The determining may include dynamically changing the selected number of expert networks to be activated for the specific router responsive to the first bias value being smaller than the second bias value and to the first uniformity value being larger than the second uniformity value by considering the expert weight for each token.

In a general aspect, here is provided a computer-readable storage medium storing instructions configured to cause, when executed by a processor, an apparatus including the processor configures the processor to perform specific operations including collecting update setting values for a mixture-of-experts language model, executing inference using the mixture-of-experts language model and collecting expert weights generated by a router of a layer of the mixture-of-experts language model to select an expert network to distribute tokens from among a plurality of expert networks, and updating a selected number of expert networks to be activated for the router of the layer, based on the expert weights and the update setting values.

The collecting of the setting values may include collecting a first ratio of a first router, the first router having a first selected number is set to a first value and a second ratio of a second router, the second router having a selected number set to a second value, from among all routers included in the mixture-of-experts language model and updating conditions for the selected number.

The updating may include updating the selected number configured in the router of the layer, responsive to the updated conditions being satisfied, based on the collected expert weights, the first ratio, and the second ratio.

The expert weights may be values calculated based on a degree of association between the tokens and the plurality of expert networks, the expert weights including a plurality of weight elements corresponding to the plurality of expert networks, each of the weight elements may be a value between 0 and 1, and a sum of the plurality of weight elements corresponding to the plurality of expert networks may be 1.

### BRIEF DESCRIPTION OF THE DRAWINGS

FIG. 1 is a diagram illustrating the configuration of a mixture-of-experts language model control system according to an embodiment of the present disclosure;

FIG. 2 is a flowchart illustrating a mixture-of-experts language model control method according to an embodiment of the present disclosure.

FIG. 3 is a diagram illustrating a specific configuration and operation of a mixture-of-experts language model control system according to an embodiment of the present disclosure.

FIG. 4 is a flowchart illustrating an updating step of a mixture-of-experts language model control method according to an embodiment of the present disclosure.

FIG. 5 is a diagram illustrating a routing policy update in a mixture-of-experts language model control method according to an embodiment of the present disclosure.

FIG. 6 is a flowchart illustrating a specific operation of a mixture-of-experts language model control method according to an embodiment of the present disclosure.

FIGS. 7 and 8 are diagrams illustrating test result data in a mixture-of-experts language model control method according to an embodiment of the present disclosure.

FIG. 9 is a diagram illustrating the configuration of a computing device according to an embodiment of the present disclosure.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used in connection with various example embodiments of the disclosure, any use of the terms “module” or “unit” means hardware and/or processing hardware configured to implement software processor or computer executable instructions (e.g., as code segment(s), program(s), and/or firmware) to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software executable instructions may include components such as software program components, object-oriented software code or program components, class components, and may include processor task components, processes, functions, attributes, procedures, subroutines, segments of the software code or program. Software Executable instructions may further include programs code, drivers, firmware, microcode, circuits, data, database, data structures, tables, arrays, and variables. In another non-limiting example, such software executable instructions may be executed by one or more central processing units (CPUs) of an electronic device or secure multimedia card.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

As used in connection with various example embodiments of the disclosure, any use of the terms “module” or “unit” means hardware and/or processing hardware configured to implement software and/or firmware to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

The present disclosure has been made to solve the problems of the above-mentioned prior art, and is to provide an adaptive routing method, apparatus, system, and computer program for a mixture-of-experts language model, which enable processing while changing the number of expert networks activated in an MoE language model.

Hereinafter, embodiments of a mixture-of-experts language model (MoE) language model control method, apparatus, system, and computer program according to the present disclosure will be described in detail with reference to the attached drawings.

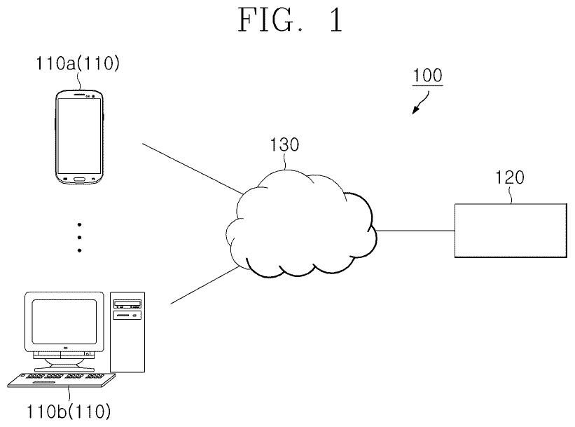

FIG. 1 illustrates the configuration and operation of an MoE language model control system 100 according to an embodiment of the present disclosure.

As shown in FIG. 1, the MoE language model control system 100 according to an embodiment of the present disclosure may be configured to include one or more terminals 110a and 110b capable of providing functions of processing a user input to the MoE language model or output therefrom or enabling the user to input setting values for the MoE language model, and an MoE language model control device 120 capable of performing operations by reflecting the users input or settings.

In this case, various terminals capable of providing the user with a user environment for the MoE language model, such as a personal computer (PC), a laptop PC, a tablet PC, a smartphone, or a PDA, may be used as the terminals 110a and 110b, but the present disclosure is not necessarily limited thereto, and in addition, various devices, such as a relay device, capable of providing the user with results processed by the MoE language model or providing information about the setting values of the MoE language model or the like to the MoE language model control device 120, in communication with the user's device, may be used as the terminals 110a and 110b.

In addition, the MoE language model control device 120 may be implemented as a system capable of driving or controlling the MoE language model using one or more physical server devices, but the present disclosure is not necessarily limited thereto, and in addition, it may be configured using personal computer processing devices such as a desktop computer, laptop, tablet, or smartphone, or configured based on a cloud system, or implemented in various forms such as a dedicated device.

In addition, the MoE language model control device 120 may be implemented as a single device that is configured integrally with the MoE language model, but the present disclosure is not necessarily limited thereto, and the MoE language model control device 120 may also be implemented as a device separate from the MoE language model.

Furthermore, the terminals 110a and 110b and the MoE language model control device 120 may also be configured in the form of a server by combining them.

In addition, the network 130 connecting the terminals 110a and 110b and the MoE language model control device 120 in FIG. 1 may be a wired network and a wireless network, and specifically, may include various communication networks such as a local area network (LAN), a metropolitan area network (MAN), and a wide area network (WAN). In addition, the network 130 may also include the World Wide Web (WWW). In addition, the network 130 may be implemented using a data bus configured to transmit and receive data or the like.

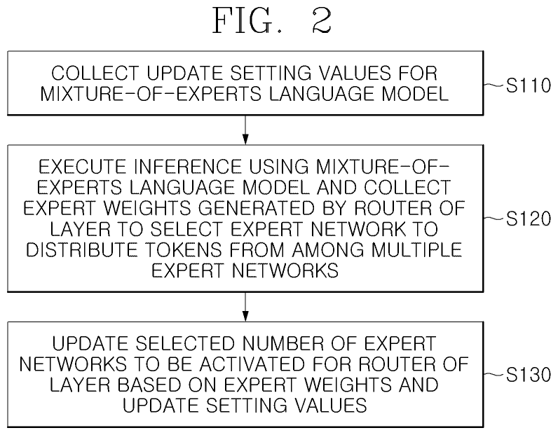

In addition, FIG. 2 illustrates a flowchart of a mixture-of-experts (MoE) language model control method according to an embodiment of the present disclosure.

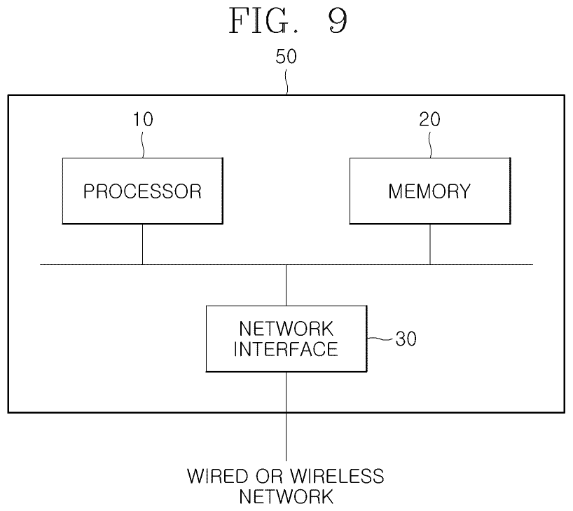

Here, the method illustrated in FIG. 2 may be performed by, for example, a mixture-of-experts (MoE) language model control device 120, and furthermore, the MoE language model control device 120 may be implemented to include a computing device 50, which will be described later with reference to FIG. 9. For example, the MoE language model control device 120 may have a processor 10, and the processor 10 may execute instructions configured to implement operations of adaptively controlling the selected number of expert networks activated in a layer of the MoE language model.

More specifically, according to an embodiment of the present disclosure, as shown in FIG. 2, the MoE language model control method of adaptively changing the selected number of expert networks activated in one or more layers of the MoE language model using a computing device 50 such as the MoE language model control device 120 may include a step S110 of collecting update setting values for a mixture-of-experts language model, a step S120 of executing inference using a mixture-of-experts language model and collecting expert weights generated by a router of a layer to select an expert network to distribute tokens from among a plurality of expert networks, and a step S130 of updating the selected number of expert networks to be activated for the router of the layer on the basis of the expert weights and the update setting values.

Here, in the step S110 of collecting the setting values, a first ratio of a router whose selected number is set to a first value and a second ratio of a router whose selected number is set to a second value, among all routers included in the mixture-of-experts language model, and update conditions for the selected number may be collected.

In addition, in the step S130 of updating, if the update conditions are satisfied, the selected number configured in the router may be updated on the basis of the collected expert weights, the first ratio, and the second ratio.

In addition, the expert weight is a value calculated based on the degree of association between the tokens and the plurality of expert networks, and may include a plurality of weight elements corresponding to the plurality of expert networks, and each of the weight elements may have a value between 0 and 1, and the sum of the plurality of weight elements corresponding to the plurality of expert networks may be 1.

In this case, the expert weight may be calculated by the router of the layer on the basis of a ratio for distributing the tokens to the plurality of expert networks.

In addition, the step S130 of updating may include a step S131 of calculating a first bias value indicating the degree of bias of expert weights for all of the layers of the mixture-of-experts language model and a first uniformity value indicating the degree of uniformity therefor, based on the expert weights and the first and second ratios, a step S132 of calculating a second bias value indicating the degree of bias of expert weights for a specific layer of the mixture-of-experts language model and a second uniformity value indicating the degree of uniformity therefor, based on the expert weights and the first and second ratios, and a step S133 of determining the selected number of expert networks to be activated for a router of the specific layer by comparing the first bias value and the first uniformity value with the second bias value and the second uniformity value.

In addition, in the step S133 of determining, the selected number of expert networks to be activated for the router of the specific layer may be determined by combining comparison results between the first bias value and the second bias value and comparison results between the first uniformity value and the second uniformity value.

Furthermore, in the step S133 of determining, if the first bias value is smaller than the second bias value and if the first uniformity value is larger than the second uniformity value, the selected number of expert networks to be activated for the router of the specific layer may be dynamically changed by considering the expert weight for each token.

Accordingly, in the adaptive routing method, apparatus, system, and computer program for a mixture-of-experts language model according to an embodiment of the present disclosure, it is possible to perform processing while changing the number of expert networks activated in the MoE language model and to perform efficient processing by adaptively responding to the characteristics of data input to the MoE language model.

Hereinafter, the configuration and operation of the MoE language model control method, apparatus, and system 100 according to an embodiment of the present disclosure will be described in more detail with reference to the respective drawings.

First, in step S110, the computing device 50 such as the mixture-of-experts language model control device 120 collects update setting values for the mixture-of-experts language model.

Here, the mixture-of-experts language model may indicate an artificial intelligence model configured by replacing a unit network such as a feed forward network (FFN) provided in a transformer layer in a language model such as a large language model by a router and a plurality of expert networks, but the present disclosure is not necessarily limited thereto.

In this case, in step S110, a first ratio of a router whose selected number is set to a first value and a second ratio of a router whose selected number is set to a second value, among all routers included in the mixture-of-experts language model, and update conditions for the selected number may be collected.

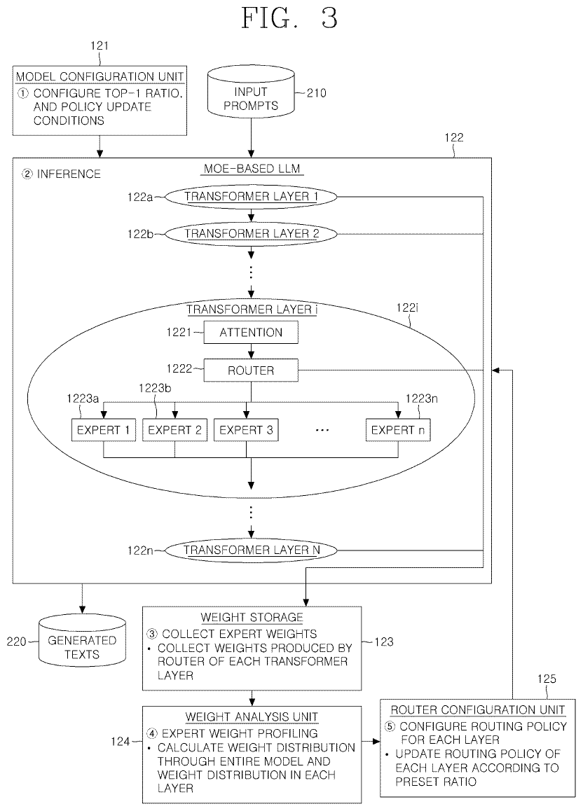

As a more specific example, referring to FIG. 3, the mixture-of-experts language model control device 120 may be configured to include a model configuration unit 121 that configures the collected update setting values, a model inference unit 122 that has an MoE language model and performs inference on the basis of a given input 210 to generates an output 220, a weight storage 123 that collects and stores expert weights generated in the process of performing the inference, a weight analysis unit 124 that analyzes the expert weights to analyze the weight distribution, and a router configuration unit 125 that performs configuration for the router.

In this case, as shown in FIG. 3, the MoE language model may have multiple (N) layers 122a, 122b, . . . , and 122N, and each layer may have a router 1222 and multiple (n) expert networks 1223a, 1223b, . . . , and 1223n.

In this regard, the MoE language model control device 120 may collect a first ratio of a router whose selected number is set to a first value (e.g., a top-1 ratio in which the selected number is set to 1 in \textcircled{1} of FIG. 3) and a second ratio of a router whose selected number is set to a second value (e.g., a top-3 ratio in which the selected number is set to 3 in \textcircled{1} of FIG. 3), among all routers (e.g., N routers 1222 in FIG. 3) included in the MoE language model, and update conditions for the selected number (e.g., routing policy update conditions in \textcircled{1} of FIG. 3).

As a more specific example, the top-1 ratio and the top-3 ratio may be set to a top 25% and a top 75%, respectively.

In addition, the routing policy update conditions may be configured in various ways, such as a time (for example, update once every 3 hours), the number of inferences (for example, update once every 10,000 inferences), a change in data characteristics (for example, update whenever data drift is detected), and manual update at a time desired by the user.

On the other hand, in an environment in which the characteristics of the input data do not change, the routing policy update may be selectively performed, and in this case, it is also possible to update the settings of the router once without repeating the series of processes below.

Next, in step S120, the computing device 50 such as the MoE language model control device 120 may execute inference using the MoE language model and collect expert weights generated by the router of the layer to select an expert network to distribute tokens from among the multiple expert networks.

As a more specific example, referring to FIG. 3, the MoE language model control device 120 performs inference using the MoE language model on the basis of a given input 210 to generate an output 220.

In this case, each of the layers 122a, 122b, . . . , and 122N of the MoE language model may have a router 1222 and multiple (n) expert networks 1223a, 1223b, . . . , and 1223n.

Accordingly, in step S120, for each of the layers 122a, 122b, . . . , and 122N of the MoE language model, expert weights generated by the router 1222 to select an expert network to distribute tokens from among the multiple expert networks 1223a, 1223b, . . . , and 1223n may be collected.

Here, the expert weight is a value calculated based on the degree of association between the tokens and the multiple expert networks, and may include multiple weight elements corresponding to the multiple expert networks.

In this case, each of the weight elements may have a value between 0 and 1, and the sum of the multiple weight elements corresponding to the multiple expert networks may be 1.

Furthermore, the expert weight may be calculated based on the ratio for distributing tokens to the multiple expert networks by the router of the layer, but the present disclosure is not necessarily limited thereto.

More specifically, during the inference process of the MoE language model, whenever each token passes through the router of each layer, an expert weight, which is a weight between the corresponding token and each expert network, may be calculated, and the calculated expert weight may be stored in a weight storage 123 for subsequent analysis tasks such as weight profiling.

As a more specific example, the Mixtral-8x7B model, which is one of the MoE language models, may be configured to have 8 expert networks, and the expert weights W for them may be expressed as in Equation 1 below.

$$W = ( {w}_{1} , {w}_{2} , , {w}_{8} ) , 0 < {w}_{i} < 1 , {\sum }_{i = 1}^{8} {w}_{i} = 1 \qquad Equation 1$$

In this case, if the routing policy of the corresponding layer is top-2, the router transfers tokens to two expert networks with the highest weights, performs a calculation, and then provides the weighted sum of the results to the next layer.

Next, in step S130, the computing device 50 such as the MoE language model control device 120 updates the number of expert networks to be activated for the router of the layer on the basis of the expert weights and the update setting values.

In this case, in step S130, if the update conditions are met, the selected number configured in the router may be updated on the basis of the collected expert weights, and the first ratio and the second ratio of the update setting values.

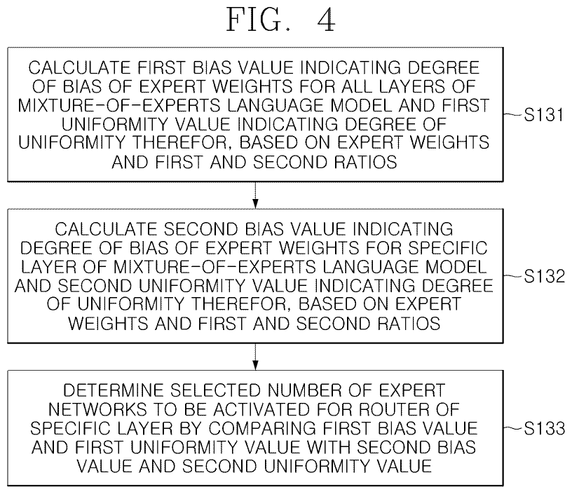

More specifically, the step S130 may include, as shown in FIG. 4, a step S131 of calculating a first bias value indicating the degree of bias of expert weights for all of the layers of the mixture-of-experts language model and a first uniformity value indicating the degree of uniformity therefor, based on the expert weights and the first and second ratios, a step S132 of calculating a second bias value indicating the degree of bias of expert weights for a specific layer of the mixture-of-experts language model and a second uniformity value indicating the degree of uniformity therefor, based on the expert weights and the first and second ratios, and a step S133 of determining the selected number of expert networks to be activated for the router of the specific layer by comparing the first bias value and the first uniformity value with the second bias value and the second uniformity value.

As a more specific example, a weight analyzer 124 of the MoE language model control device 120 may perform weight profiling on the basis of the expert weights accumulated up to that point.

To this end, the distribution of the maximum values of the respective expert weights may be calculated for the entire MoE language model (i.e., for all the layers).

For example, in the case of the Mixtral-8x7B model having eight expert networks, if the maximum value of the expert weights is close to 1, it may be said that the degree of dependence or association with a specific expert network is high, and on the other hand, if the maximum value of the expert weights is close to ⅛=0.125, it may be determined that all expert networks have an equal degree of association.

Next, the weight analyzer 124 may calculate a corresponding bias value and uniformity value according to the top-1 ratio and top-3 ratio configured by the model configuration unit 121.

As a more specific example, referring to Equation 2 below, if the top-1 ratio is set to 25% and the top-3 ratio is set to 75%, the first bias value (α) may be the 1st quartile for the maximum values of all the expert weights, and the first uniformity value (β) may be the 3rd quartile for the maximum values of all the expert weights (step S131).

$$\frac{n ( W \vert max ( W ) \geq α )}{n ( W )} = 0.25 , \frac{n ( W \vert max ( W ) \geq β )}{n ( W )} = 0.75 . \qquad Equation 2$$

Here, max(W) indicates the maximum value of the expert weight W, and n(W) indicates the number of expert weights.

In addition, the weight analyzer 124 recognizes the distribution of the maximum values of respective expert weights for each layer.

More specifically, the weight analyzer 124 may calculate a top-1 ratio and a top-3 ratio for the maximum values of respective expert weights generated in a specific layer.

In this case, referring to Equation 3 below, similarly to the entire model (i.e., all of the layers), if the top-1 ratio is 25% and the top-3 ratio is 75%, the second bias value (αᵢ) for layer i may be the 1st quartile for the maximum values of the expert weights generated in the corresponding layer, and the second uniformity value (βᵢ) may be the 3rd quartile for the maximum values of the expert weights generated in the corresponding layer (step S132).

$$\frac{n ( {W}_{i} \vert max ( {W}_{i} ) \geq {α}_{i} )}{n ( {W}_{i} )} = 0.25 , \frac{n ( {W}_{i} \vert max ( {W}_{i} ) \geq {β}_{i} )}{n ( {W}_{i} )} = 0.75 \qquad Equation 3$$

Next, the router configuration unit 125 of the MoE language model control device 120 may configure a routing policy for the router of each layer, based on the analysis result produced by the weight analyzer 124 (step S133).

More specifically, in step S133, the selected number of expert networks to be activated for the router of a specific layer may be determined by combining the comparison results between the first bias value (α) and the second bias value (αᵢ) and the comparison results between the first uniformity value (β) and the second uniformity value (βᵢ).

Furthermore, in step S133, if the first bias value (α) is smaller than the second bias value (αᵢ) and if the first uniformity value (β) is larger than the second uniformity value (βᵢ), it is also possible to dynamically change the selected number of expert networks to be activated for the router of the specific layer by considering the expert weight for each token.

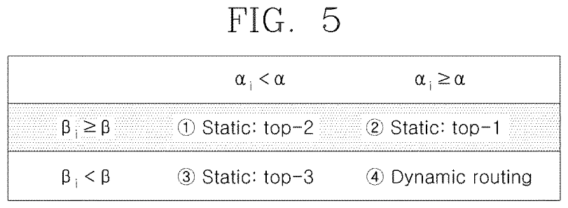

As a more specific example, referring to FIG. 5, the router configuration unit 125 of the MoE language model control device 120 according to an embodiment of the present disclosure is able to determine a routing policy for a total of four cases by comparing the first bias value (α) and the first uniformity value (β) with the second bias value (αᵢ) and the second uniformity value (βᵢ).

In this case, the fact that the second bias value (αᵢ) is smaller than the first bias value (α) may indicate that the expert weights of the corresponding layer i are less biased, compared to the entire model, whereas the fact that the second bias value (αᵢ) is larger than the first bias value (α) may indicate that the expert weights of the corresponding layer i are more biased, compared to the entire model.

In addition, the fact that the second uniformity value (βᵢ) is smaller than the first uniformity value (β) may indicate that the expert weights of the corresponding layer i are more evenly distributed, compared to the entire model, whereas the fact that the second uniformity value (βᵢ) is larger than the first uniformity value (β) may indicate that the expert weights of the corresponding layer i are less evenly distributed, compared to the entire model.

Accordingly, referring to FIG. 5, there are few biased expert weights and few uniform expert weights in the case of αᵢ<α, βᵢ>β (Case \textcircled{1} in FIG. 5), so the router of the corresponding layer may be configured as top-2, and there are many biased expert weights and few uniform expert weights in the case of αᵢ>α, βᵢ>β (Case \textcircled{2} in FIG. 5), so the router of the corresponding layer may be configured as top-1, and there are few biased expert weights and many uniform expert weights in the case of αᵢ<α, βᵢ<β (Case \textcircled{3} in FIG. 5), so the router of the corresponding layer may be configured as top-3.

Furthermore, in the case of αᵢ>α, βᵢ<β (Case \textcircled{4} in FIG. 5), there are relatively many biased expert weights and many uniform expert weights, so the router of the corresponding layer may be configured as dynamic routing.

In this case, in layer i performing dynamic routing, routing may be performed while adjusting the value k depending on the expert weights of each token the, as in Equation 4, instead of using a fixed value (top-k).

$$\begin{matrix}max ( {W}_{it} ) \geq {α}_{i} \to k = 1 , \\ max ( {W}_{it} ) < {β}_{i} \to k = 3 , \\ {β}_{i} \leq max ( {W}_{it} ) < {α}_{i} \to k = 2\end{matrix} \qquad Equation 4$$

Accordingly, the router configuration unit 125 of the MoE language model control device 120 may apply the determined routing policy to the router of each layer and then, if the routing policy update conditions are satisfied while performing inference, update the routing policy for the router of each layer by repeating the series of processes above.

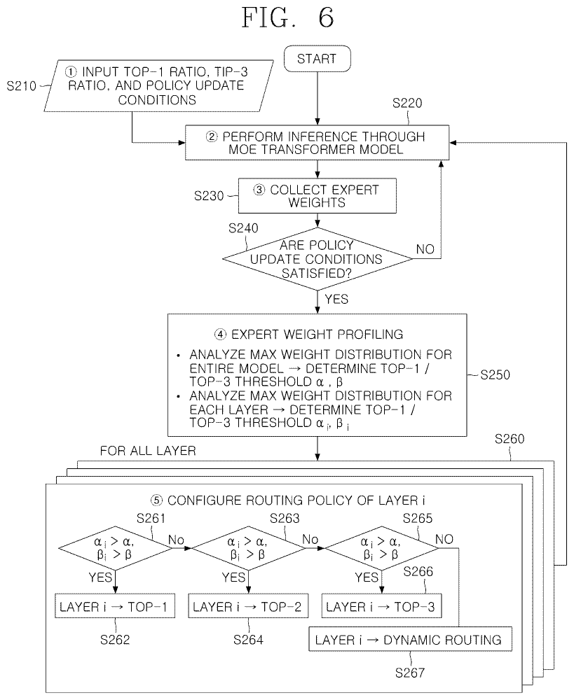

In this regard, FIG. 6 illustrates a flowchart illustrating the specific operation of a mixture-of-experts language model control method according to an embodiment of the present disclosure.

As shown in FIG. 6, the MoE language model control device 120 collects update setting values such as top-1 ratio, top-3 ratio, and routing policy update conditions input by the user (S210).

Subsequently, the MoE language model control device 120 performs inference on the given input using the MoE language model (S220).

Accordingly, the MoE language model control device 120 collects expert weights generated through the inference (S230).

At this time, the MoE language model control device 120 may determine whether or not the routing policy update conditions are met (S240).

Subsequently, the MoE language model control device 120 performs analysis on the expert weights (S250).

Accordingly, the MoE language model control device 120 configures a routing policy for each layer of the MoE language model on the basis of the results of the analysis (S260).

More specifically, the MoE language model control device 120 may configure, in the case of αᵢ>α, βᵢ>β (S261), the corresponding layer i as top-1 (S262), may configure, in the case of αᵢ<α, βᵢ>β (S263), the corresponding layer i as top-2 (S264), may configure, in the case of αᵢ<α, βᵢ<β (S265), the corresponding layer i as top-3 (S266), and may configure the corresponding layer i as dynamic routing in the case of αᵢ>α, βᵢ<β (S267).

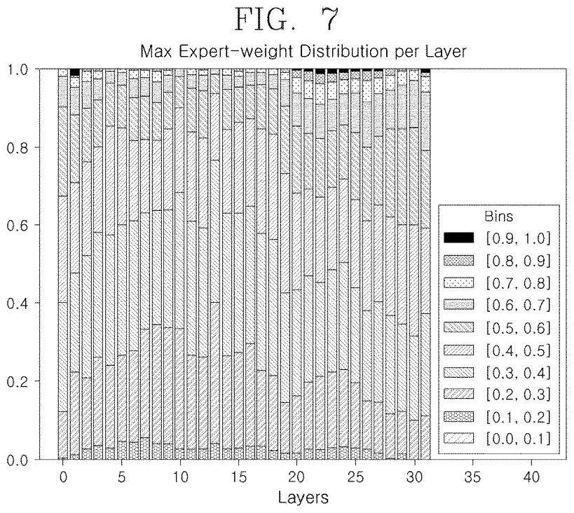

In addition, FIG. 7 illustrates the results of weight profiling for each layer of the Mixtral-8x7B model, which is one of the MoE language models.

As shown in FIG. 7, it can be seen that the degree of bias of the expert weight differs between the layers in the Mixtral-8x7B model, and accordingly, it is possible to implement optimized routing for each layer and process tokens more efficiently by applying the adaptive routing technique according to the present disclosure.

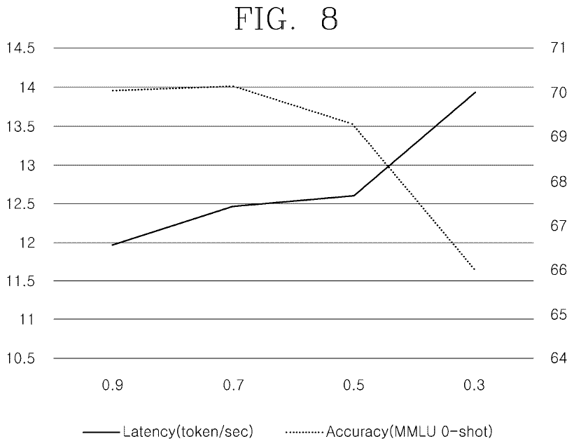

In addition, FIG. 8 illustrates results of the dynamic routing test for the Mixtral-8x7B model.

In FIG. 8, dynamic routing was performed by configuring each token as top-1 if the maximum value of the expert weight exceeds a threshold and configuring the same as top-2 if the maximum value of the expert weight does not exceed the threshold.

In this case, as shown in FIG. 8, it is identified to exhibit a trade-off feature in which the inference speed increases as the threshold decreases, but the accuracy decreases.

In addition, a computer program according to another aspect of the present disclosure may be a computer program stored in a computer-readable medium for executing a series of steps of the mixture-of-experts language model control method described above in a computer. The computer program may be a computer program including machine language codes created by a compiler, and a computer program including high-level language codes executable in a computer using an interpreter or the like. In this case, the computer includes, in addition to a personal computer (PC) or a laptop computer, any type of information processing device equipped with a central processing unit (CPU) to execute a computer program, such as a server, a smartphone, a tablet PC, a PDA, or a mobile phone.

In addition, the computer-readable medium may be a medium that continuously stores a computer-executable program, or temporarily stores it for execution or download. In addition, the medium may be a variety of recording means or storage means in the form of a single piece of hardware or a combination of multiple pieces of hardware, and may not be limited to a medium directly connected to a computer system, but may also be distributed on a network. Therefore, the above detailed description should not be construed as limiting the present disclosure in all respects and should be considered as examples. The scope of the present disclosure should be determined by a reasonable interpretation of the appended claims, and all changes within the equivalent scope of the present disclosure are included in the scope of the present disclosure.

In addition, in a mixture-of-experts language model control device 120 according to an embodiment of the present disclosure, an apparatus for adaptively changing a selected number of expert networks to be activated in one or more layers of a mixture-of-experts language model may include a processor and a memory, and the memory may store instructions configured to cause, when executed by the processor, the apparatus to perform specific operations, and the specific operations may include: collecting update setting values for the mixture-of-experts language model; executing inference using the mixture-of-experts language model and collecting expert weights generated by a router of the layer to select an expert network to distribute tokens from among a plurality of expert networks; and updating the selected number of expert networks to be activated for the router of the layer on the basis of the expert weights and the update setting values.

In this case, the mixture-of-experts language model control device 120 according to an embodiment of the present disclosure may be easily implemented and executed based on the mixture-of-experts language model control method described above with reference to FIGS. 1 to 8. Therefore, redundant description will be omitted below and the priority configurations of the present disclosure will be described.

Here, the collecting of the setting values may include collecting a first ratio of a router whose selected number is set to a first value and a second ratio of a router whose selected number is set to a second value, among all routers included in the mixture-of-experts language model, and update conditions for the selected number.

In addition, the updating may include, if the update conditions are satisfied, updating the selected number configured in the router on the basis of the collected expert weights, the first ratio, and the second ratio.

In addition, the expert weight may be a value calculated based on the degree of association between the tokens and the plurality of expert networks, and may include a plurality of weight elements corresponding to the plurality of expert networks, and each of the weight elements may have a value between 0 and 1, and the sum of the plurality of weight elements corresponding to the plurality of expert networks may be 1.

In this case, the expert weight may be calculated by the router of the layer on the basis of a ratio for distributing the tokens to the plurality of expert networks.

In addition, the updating may include: calculating a first bias value indicating the degree of bias of expert weights for all of the layers of the mixture-of-experts language model and a first uniformity value indicating the degree of uniformity therefor, based on the expert weights and the first and second ratios; calculating a second bias value indicating the degree of bias of expert weights for a specific layer of the mixture-of-experts language model and a second uniformity value indicating the degree of uniformity therefor, based on the expert weights and the first and second ratios; and determining the selected number of expert networks to be activated for a router of the specific layer by comparing the first bias value and the first uniformity value with the second bias value and the second uniformity value.

In addition, the determining may include determining the selected number of expert networks to be activated for the router of the specific layer by combining comparison results between the first bias value and the second bias value and comparison results between the first uniformity value and the second uniformity value.

Furthermore, the determining may include, if the first bias value is smaller than the second bias value and if the first uniformity value is larger than the second uniformity value, dynamically changing the selected number of expert networks to be activated for the router of the specific layer by considering the expert weight for each token.

In addition, FIG. 9 illustrates a computing device 50 to which the proposed method of the present disclosure may be applied.

Referring to FIG. 9, the computing device 50 may be configured to implement a mixture-of-experts language model control process according to the proposed method of the present disclosure.

For example, the computing device 50 to which the proposed method of the present disclosure may be applied may include network devices such as repeaters, hubs, bridges, switches, routers, gateways, and the like, computer devices such as desktop computers, workstations, and the like, mobile terminals such as smartphones and the like, portable devices such as laptop computers and the like, home appliances such as digital TVs and the like, and moving means such as vehicles and the like. As another example, the computing device 50 to which the present disclosure may be applied may be included as part of an ASIC (Application Specific Integrated Circuit) implemented in the form of a SoC (System on Chip).

The memory 20 may be connected to the processor 10 during operation, and may store programs and/or instructions for processing and controlling the processor 10, and may store data and information used in the present disclosure, control information required for processing data and information according to the present disclosure, and temporary data generated during the data and information processing process. The memory 20 may be implemented as a storage device such as a ROM (Read-Only Memory), a RAM (Random Access Memory), an EPROM (Erasable Programmable Read-Only Memory), an EEPROM (Electrically Erasable Programmable Read-Only Memory), a flash memory, a SRAM (Static RAM), an HDD (Hard Disk Drive), an SSD (Solid State Drive), and the like.

The processor 10 may be operatively connected to the memory 20 and/or the network interface 30, and may control the operation of respective modules in the computing device 50. In particular, the processor 10 may perform various control functions for performing the proposed method of the present disclosure. The processor 10 may also be called a controller, a micro-controller, a micro-processor, a micro-computer, or the like. The proposed method of the present disclosure may be implemented by hardware, firmware, software, or a combination thereof. When implementing the present disclosure using hardware, an ASIC (application specific integrated circuit) or a DSP (digital signal processor), a DSPD (digital signal processing device), a PLD (programmable logic device), an FPGA (field programmable gate array), or the like, configured to perform the present disclosure, may be provided in the processor 10. Meanwhile, when implementing the proposed method of the present disclosure using firmware or software, the firmware or software may include instructions related to modules, procedures, or functions that perform functions or operations necessary for implementing the proposed method of the present disclosure, and the instructions may be stored in the memory 20 or stored in a computer-readable recording medium (not shown) separate from the memory 20, and may be configured to cause, when executed by the processor 10, the device 50 to perform the proposed method of the present disclosure.

In addition, the computing device 50 may include a network interface device 30. The network interface device 30 may be connected to the processor 10 during operation, and the processor 10 may control the network interface device 30 to transmit or receive wireless/wired signals carrying information, data, signals, and/or messages through a wireless/wired network. The network interface device 30 may support various communication standards such as IEEE 802 series, 3GPP LTE(-A), 3GPP 5G, etc., and may transmit and receive control information and/or data signals according to the corresponding communication standards. The network interface device 30 may be implemented outside the computing device 50 as needed.

Accordingly, in the adaptive routing method, apparatus, system, and computer program for a mixture-of-experts language model according to an embodiment of the present disclosure, processing may be performed while changing the number of expert networks to be activated in the MoE language model, and efficient processing is possible by adaptively responding to the characteristics of data input to the MoE language model.

The computing devices, processors, memories, modules, units, systems, apparatuses, MoE language model control system 100, terminals 110a and 110b, MoE language model control device 120, model configuration unit 121, network 130, weight storage 123, router 1222, multiple (n) expert networks 1223a, 1223b, . . . , and 1223n, computing device 50, processor 10, memory 20, and network interface 30 described herein and disclosed herein described with respect to FIGS. 1-9 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
collecting update setting values for a mixture-of-experts language model;
executing inference using the mixture-of-experts language model and collecting expert weights generated by a router of a layer of the mixture-of-experts language model to select an expert network to distribute tokens from among a plurality of expert networks; and
updating a selected number of expert networks to be activated for the router of the layer, based on the expert weights and the update setting values.

2. The method according to claim 1, wherein the collecting of the setting values comprises:
collecting a first ratio of a first router, the first router having a first selected number set to a first value and a second ratio of a second router, the second router having a second selected number set to a second value, from among all routers included in the mixture-of-experts language model; and
updating conditions for the selected number.

3. The method according to claim 2, wherein the updating comprises:
updating the selected number configured in the router of the layer, responsive to the updated conditions being satisfied, based on the collected expert weights, the first ratio, and the second ratio.

4. The method according to claim 1, wherein the expert weights are values calculated based on a degree of association between the tokens and the plurality of expert networks, the expert weights comprising a plurality of weight elements corresponding to the plurality of expert networks,
wherein each of the weight elements has a value between 0 and 1, and
wherein a sum of the plurality of weight elements corresponding to the plurality of expert networks is 1.

5. The method according to claim 4, wherein the expert weights are calculated by the router of the layer, based on a ratio for distributing the tokens to the plurality of expert networks.

6. The method according to claim 2, wherein the updating comprises:
calculating a first bias value indicating a first degree of bias of all expert weights for all layers of the mixture-of-experts language model and a first uniformity value indicating a degree of uniformity therefor, based on the expert weights and the first and second ratios;
calculating a second bias value indicating a second degree of bias of specific expert weights for a specific layer of the mixture-of-experts language model and a second uniformity value indicating a degree of uniformity therefor, based on the expert weights and the first and second ratios; and
determining the selected number of expert networks to be activated for a specific router of the specific layer by comparing the first bias value and the first uniformity value with the second bias value and the second uniformity value.

7. The method according to claim 6, wherein the determining comprises:
determining the selected number of expert networks to be activated for the specific router by combining comparison results between the first bias value and the second bias value and comparison results between the first uniformity value and the second uniformity value.

8. The method according to claim 7, wherein the determining comprises:
dynamically changing the selected number of expert networks to be activated for the specific router responsive to the first bias value being smaller than the second bias value and to the first uniformity value being larger than the second uniformity value by considering the expert weight for each token.

9. An apparatus, comprising:
a processor configured to execute instructions; and
a memory storing the instructions, wherein execution of the instructions configures the processor to: collect update setting values for a mixture-of-experts language model;
execute inference using the mixture-of-experts language model and collecting expert weights generated by a router of a layer of the mixture-of-experts language model to select an expert network to distribute tokens from among a plurality of expert networks; and
update a selected number of expert networks to be activated for the router of the layer, based on the expert weights and the update setting values.

10. The apparatus according to claim 9, wherein the collecting of the setting values comprises:
collecting a first ratio of a first router, the first router having a first selected number set to a first value and a second ratio of a second router, the second router having a second selected number set to a second value, from among all routers included in the mixture-of-experts language model; and
updating conditions for the selected number.

11. The apparatus according to claim 10, wherein the updating comprises:
updating the selected number configured in the router of the layer responsive to the updated conditions being satisfied based on the collected expert weights, the first ratio, and the second ratio.

12. The apparatus according to claim 9, wherein the expert weights are values calculated based on a degree of association between the tokens and the plurality of expert networks, the expert weight comprising a plurality of weight elements corresponding to the plurality of expert networks,
wherein each of the weight elements include a value between 0 and 1, and
wherein a sum of the plurality of weight elements corresponding to the plurality of expert networks is 1.

13. The apparatus according to claim 12, wherein the expert weights are calculated by the router of the layer based on a ratio for distributing the tokens to the plurality of expert networks.

14. The apparatus according to claim 10, wherein the updating comprises:
calculating a first bias value indicating a degree of bias of all expert weights for all layers of the mixture-of-experts language model and a first uniformity value indicating the degree of uniformity therefor based on the expert weights and the first and second ratios;
calculating a second bias value indicating a second degree of bias of specific expert weights for a specific layer of the mixture-of-experts language model and a second uniformity value indicating a degree of uniformity therefor based on the expert weights and the first and second ratios; and
determining the selected number of expert networks to be activated for a specific router of the specific layer by comparing the first bias value and the first uniformity value with the second bias value and the second uniformity value.

15. The apparatus according to claim 14, wherein the determining comprises:
determining the selected number of expert networks to be activated for the specific router by combining comparison results between the first bias value and the second bias value and comparison results between the first uniformity value and the second uniformity value.

16. The apparatus according to claim 15, wherein the determining comprises:
dynamically changing the selected number of expert networks to be activated for the specific router responsive to the first bias value being smaller than the second bias value and to the first uniformity value being larger than the second uniformity value by considering the expert weight for each token.

17. A computer-readable storage medium storing instructions configured to cause, when executed by a processor, an apparatus which comprises the processor configures the processor to perform specific operations the operations comprising:
collecting update setting values for a mixture-of-experts language model;
executing inference using the mixture-of-experts language model and collecting expert weights generated by a router of a layer of the mixture-of-experts language model to select an expert network to distribute tokens from among a plurality of expert networks; and
updating a selected number of expert networks to be activated for the router of the layer, based on the expert weights and the update setting values.

18. The computer-readable storage medium according to claim 17, wherein the collecting of the setting values comprises:
collecting a first ratio of a first router, the first router having a first selected number is set to a first value and a second ratio of a second router, the second router having a selected number set to a second value, from among all routers included in the mixture-of-experts language model; and
updating conditions for the selected number.

19. The computer-readable storage medium according to claim 18, wherein the updating comprises:
updating the selected number configured in the router of the layer, responsive to the updated conditions being satisfied, based on the collected expert weights, the first ratio, and the second ratio.

20. The computer-readable storage medium according to claim 17, wherein the expert weights are values calculated based on a degree of association between the tokens and the plurality of expert networks, the expert weights comprising a plurality of weight elements corresponding to the plurality of expert networks,
wherein each of the weight elements include a value between 0 and 1, and
wherein a sum of the plurality of weight elements corresponding to the plurality of expert networks is 1.
